(19) United States
(12) Patent Application Publication
(10) Pub. No.: US 2006/0022110 A1
(43) Pub. Date: Feb. 2, 2006

(54) Hydraulic antivibration device and elastic partition membrane and sandwiching members for use in the same

(75) Inventors: Kentarou Yamamoto, Osaka-shi (JP); Yasuhiro Tananka, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKYO TIRE & RUBBER CO., LTD.,, Osaka-shi (JP)

(21) Appl. No.: 10/534,406

(22) PCT Filed: Mar. 31, 2004
(86) PCT No.: PCT/JP04/04727

§ 371 Date: May 11, 2005

(51) Int. Cl. F16M 13/00

(52) U.S. Cl. 248/636

(57) ABSTRACT

A hydraulic antivibration device is provided that is capable of reducing greatly strange sound upon inputting of high amplitude while meeting both a low dynamic spring characteristic upon inputting of low amplitude and a high damping characteristic upon inputting of high amplitude. According to the device 100 of the invention, because an elastic partition membrane 15 is arrested by displacement-regulating ribs 17, 19 to regulate its displacement, and openings 54, 56 are pierced to provide an escape for the elastic partition membrane 15, it is possible to reduce greatly strange sounds upon inputting of large amplitude while meeting both a low dynamic spring characteristic upon inputting of low amplitude and a high damping characteristic upon inputting of large amplitude (intermediate amplitude) vibration.

### TECHNICAL FIELD

This invention relates to a hydraulic antivibration device and to an elastic partition membrane and a pair of sandwiching members both used for the hydraulic antivibration device.

### BACKGROUND ART

As an antivibration device for supporting and securing an automotive engine so as not to transmit the engine vibrations to the vehicle body frame, a hydraulic style of antivibration device is well known.

In general, the hydraulic antivibration device is constructed so that a first attachment fitting to be attached to the engine side and a second attachment fitting to be attached to the body frame side are connected through a vibration-isolating base composed of a rubber-like elastomer, and a liquid-filled chamber is formed between a diaphragm attached to the second attachment fitting and the vibration-isolating base and divided by a partition into a first and a second liquid chambers, which are in turn put into communication with each other through an orifice.

According to this hydraulic antivibration device, the fluidization effect of fluid through the orifice between the first and second liquid chambers and the vibration absorbing effect of the vibration-isolating base permit the device to perform its vibration damping function and vibration insulating function.

For such hydraulic antivibration devices as this, further known are a so-called elastic membrane structure constructed so that an elastic partition membrane is disposed between the first and second liquid chambers so as to absorb the hydraulic pressure fluctuation between both liquid chambers by the reciprocating deformation of the elastic partition membrane thereby obtaining a low dynamic spring characteristic upon inputting of a small amplitude, or a so-called mobile membrane structure constructed so that displacement-regulating members are provided on both sides of the elastic partition membrane to regulate the displacement amount of the elastic partition membrane from the both sides to elevate the membrane stiffness, thereby enhancing a damping characteristic upon inputting of a large amplitude, etc.

With the elastic membrane structure, however, a problem of strange (unusual) sounds, as hereinafter described, does not arise, but since the stiffness of the elastic partition membrane is constant regardless of the amplitude, if it is intended to obtain a low dynamic spring characteristic upon inputting of a small amplitude, then upon inputting of a large amplitude the hydraulic pressure difference between both liquid chambers is liable to be alleviated, so that it is no longer possible to exhibit sufficiently the fluidization effect of fluid. Consequently there was the problem that the damping characteristic is conspicuously lowered.

On the other hand, with the mobile membrane structure, it is possible to meet both of a low dynamic spring characteristic upon inputting of small amplitude and a high damping characteristic upon inputting of large amplitude, yet because of the structure of making the elastic partition membrane abutment on the displacement-regulating members, the displacement-regulating members oscillate at the time of abutment, which oscillation is transmitted to the body frame and hence, there was the problem of generation of strange sounds.

The present invention has been made to solve the aforementioned problems, and is aimed at providing a hydraulic antivibration device that is capable of greatly reducing strange sounds as well as meeting both requirements of a low dynamic spring characteristic upon inputting of a low amplitude and a high damping characteristic upon inputting of a high amplitude and an elastic partition membrane and sandwiching members both used for the aforesaid hydraulic antivibration device.

### DISCLOSURE OF THE INVENTION

In order to achieve this object, the hydraulic antivibration device of a first invention comprises a first attachment fitting, a cylindrical second attachment fitting, a vibration-isolating base connecting the second attachment fitting and the first attachment fitting and composed of a rubber-like elastomer, a diaphragm attached to the second attachment fitting to form a liquid-filled chamber between the diaphragm and the vibration-isolating base, a partition comparting the liquid-filled chamber into a first liquid chamber on the vibration-isolating base side and a second liquid chamber on the diaphragm side, and an orifice putting the first liquid chamber and the second liquid chamber into communication with each other, the partition including an elastic partition membrane and a pair of sandwiching members pinching and holding a peripherally marginal portion of the elastic partition membrane from both faces thereof, wherein the sandwiching members include a plurality of openings pierced on the first and the second liquid chamber sides and displacement-regulating ribs for regulating the displacement of the elastic partition membrane formed alongside of peripheral margins of the respective openings, and the elastic partition membrane is provided at least at one face thereof with displacement-regulating protrusions, the displacement-regulating protrusions being situated to correspond to at least a part of the displacement-regulating ribs of the sandwiching members.

The hydraulic antivibration device of a second invention is directed to the hydraulic antivibration device of the first invention, wherein the displacement-regulating protrusions of the elastic partition membrane are provided on both faces of the elastic partition membrane and the displacement-regulating protrusions are situated to correspond to at least part of the displacement-regulating ribs of the sandwiching members.

The hydraulic antivibration device of a third invention is directed to the hydraulic antivibration device of the first or the second invention, wherein the displacement-regulating protrusions of the elastic partition membrane are constructed so that tops thereof may abut on the displacement-regulating ribs of the sandwiching members.

The hydraulic antivibration device of a fourth invention is directed to the hydraulic antivibration device of any one of the first to the third inventions, wherein the displacement-regulating ribs of each of the sandwiching members are of a plurality of radial ribs disposed in a radial fashion relative to an axis center of the sandwiching member and the displacement-regulating protrusions of the elastic partition membrane are provided in positions corresponding to at least a half or more of a plurality of the radial ribs.

The hydraulic antivibration device of a fifth invention is directed to the hydraulic antivibration device of any one of the first to the third inventions, wherein the displacement-regulating ribs of each of the sandwiching members include an annular rib disposed in an annular fashion relative to an axis center of the sandwiching member and a plurality of linking ribs joining the annular rib to an outer periphery of the sandwiching member and disposed in a radial fashion relative to the axis center of the sandwiching member, and the displacement-regulating protrusions of the elastic partition membrane are provided only in a position corresponding to the annular rib, with the number of the linking ribs being four or less.

The hydraulic antivibration device of a sixth invention is directed to the hydraulic antivibration device of any one of the first to the third inventions, wherein the displacement-regulating ribs of each of the sandwiching members consist of an annular rib disposed in an annular fashion relative to an axis center of the each sandwiching member and a plurality of linking ribs joining the annular rib to an outer periphery of the sandwiching member and disposed in a radial fashion relative to the axis center of the sandwiching member, and the displacement-regulating protrusions of the elastic partition membrane are provided in a position corresponding to the annular rib and in positions corresponding to at least one linking rib, among a plurality of the linking ribs.

The hydraulic antivibration device of a seventh invention is directed to the hydraulic antivibration device of the sixth invention, wherein assuming the number of the linking ribs to be n, the displacement-regulating protrusions of the elastic partition membrane are provided in positions corresponding to the annular ribs and in positions corresponding to the linking ribs of [n/2−1 (n: even number) or (n+1)/2−1 (n: odd number)] or upwards, of the linking ribs of n. Here, the mark “n” stands for an integer, throughout the description of the invention.

The hydraulic antivibration device of an eighth invention is directed to the hydraulic antivibration device of the sixth or the seventh invention, wherein assuming the number of the linking ribs to be n, the displacement-regulating protrusions of the elastic partition membrane are provided in positions corresponding to the annular ribs and in positions corresponding to the linking ribs of (n−2) or upwards, wherein 2 is subtracted from all of the linking ribs, n.

The hydraulic antivibration device of a ninth invention is directed to the hydraulic antivibration device of any one of the fourth to the eighth inventions, wherein the displacement-regulating ribs or the annular ribs and the linking ribs are formed integrally with the sandwiching members.

The elastic partition membrane of a tenth invention is employed for the hydraulic antivibration device of any one of the first to the ninth inventions.

A pair of the sandwiching members of an eleventh invention is employed for the hydraulic antivibration device of any one of the first to the ninth inventions.

### BRIEF DESCRIPTION OF THE DRAWINGS

FIG. 1 is a sectional view of a hydraulic antivibration device in a first embodiment of this invention.

FIG. 2 (a) and FIG. 2 (b) are a top plan view and a side elevation, respectively, of an orifice member in the first embodiment.

FIG. 3 is a cross-sectional view of the orifice member taken along III-III line in FIG. 2 (a).

FIG. 4 (a) is a top plan view of a partition plate member in the first embodiment, and FIG. 4 (b) is a cross-sectional view of the partition plate member taken along IVb-IVb line in FIG. 4 (a).

FIG. 5 (a), FIG. 5 (b) and FIG. 5 (c) are a top plan view, a side elevation, and a bottom plan view, respectively, of an elastic partition membrane in the first embodiment.

FIG. 6 (a) is a cross-sectional view of the elastic partition membrane taken along VIa-VIa line in FIG. 5 (a), and FIG. 6 (b) is a cross-sectional view taken along VIb-VIb line in FIG. 5 (a).

FIG. 7 (a) is a top plan view of a partition in the first embodiment, and FIG. 7 (b) is a cross-sectional view of the partition taken along VIIb-VIIb line in FIG. 7 (a).

FIG. 8 (a) is a top plan view of an orifice member in a second embodiment, and FIG. 8 (b) is a side elevation of the orifice member.

FIG. 9 is a cross-sectional view of the orifice member taken along IX-IX line in FIG. 8 (a).

FIG. 10 (a) is a top plan view of a partition plate member in the second embodiment, and FIG. 10 (b) is a cross-sectional view of the partition plate member taken along Xb-Xb line in FIG. 10 (a).

FIG. 11 (a), FIG. 11 (b) and FIG. 11 (c) are a top plan view, a side elevational view, and a bottom plan view, respectively, of an elastic partition membrane in the second embodiment.

FIG. 12 (a) is a cross-sectional view of the elastic partition membrane taken along XIIa-XIIa line in

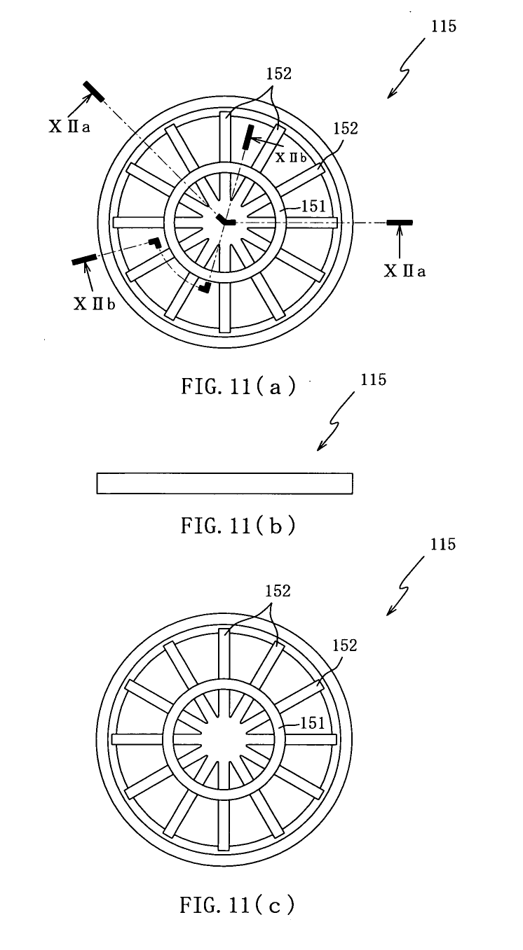

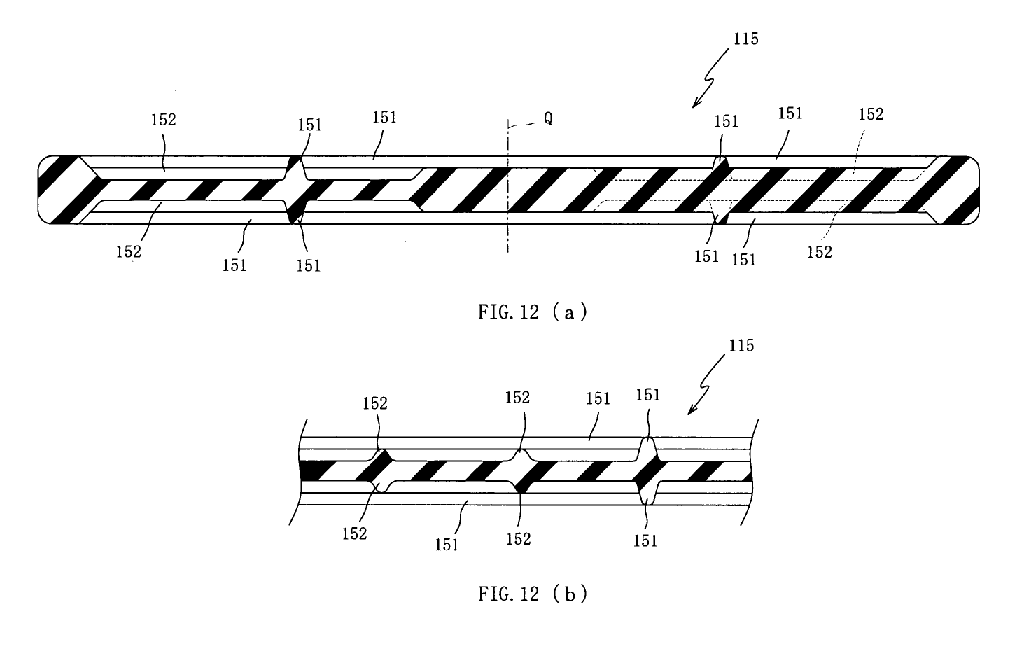

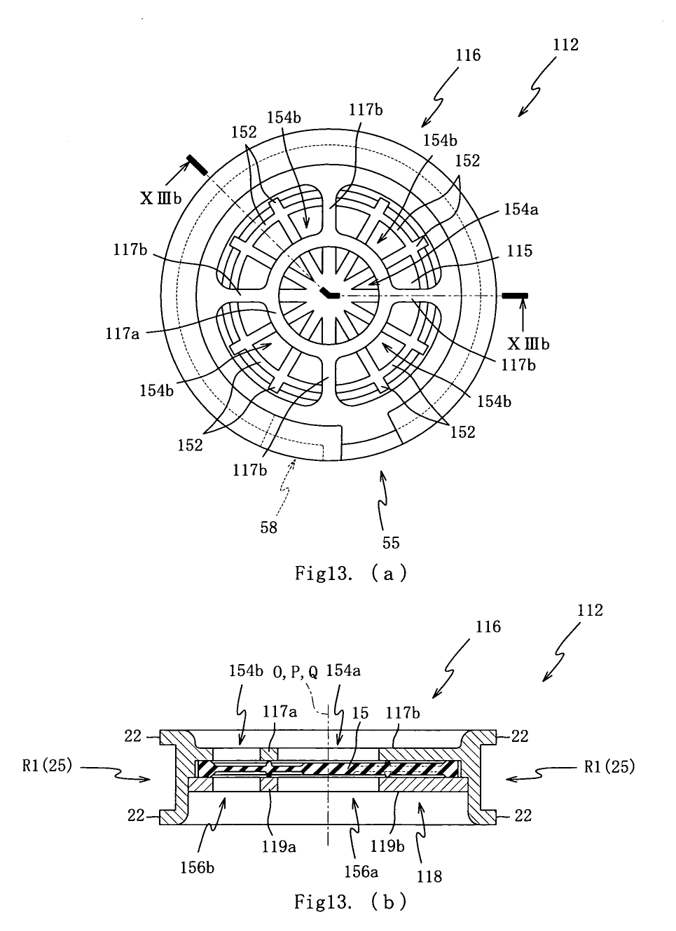

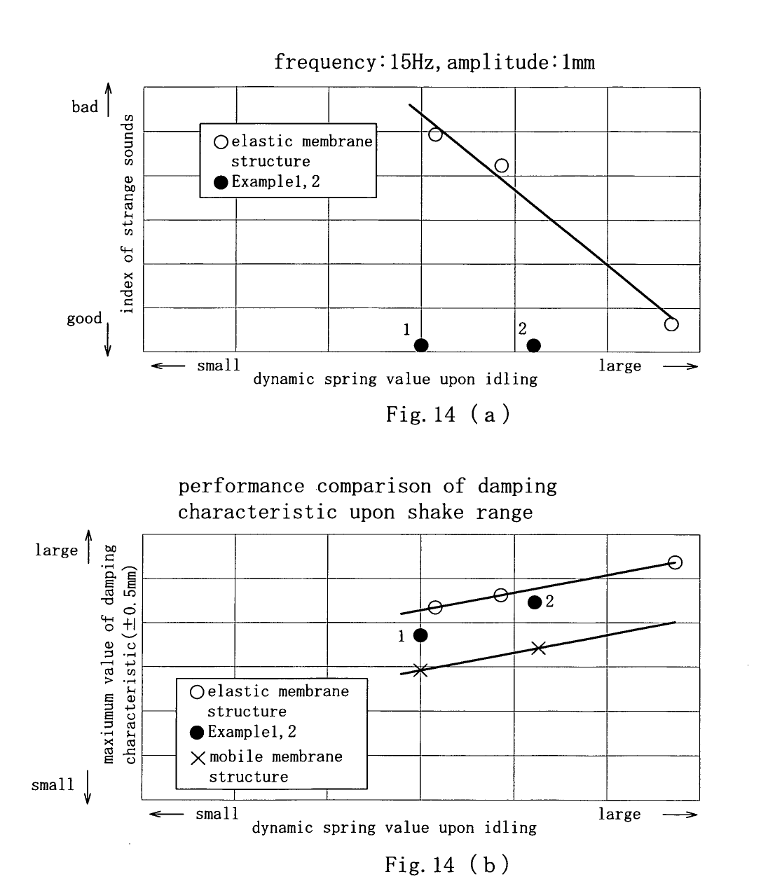

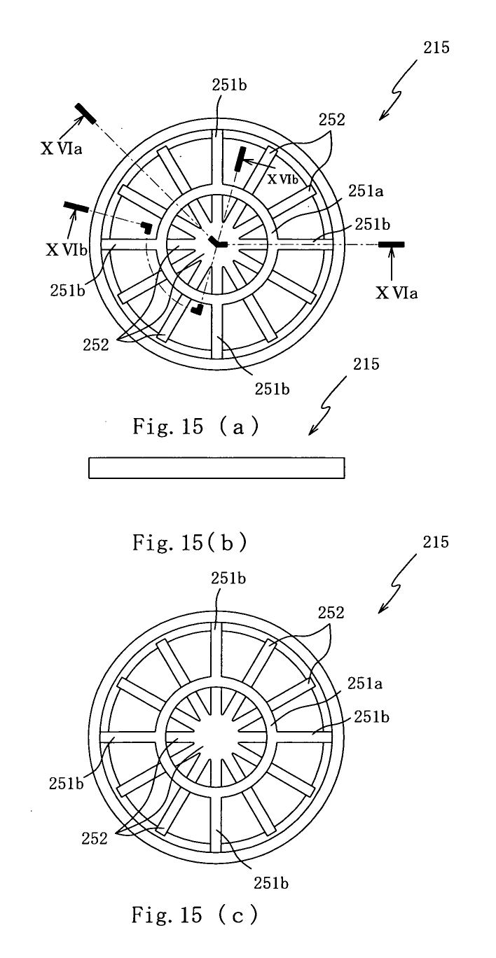

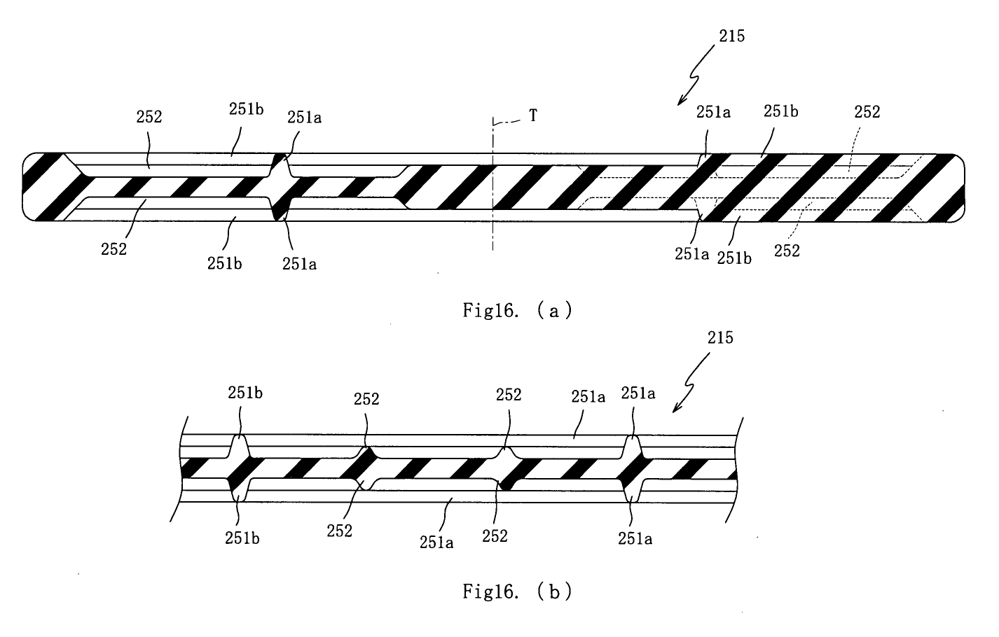

FIG. 11 (a), and FIG. 12 (b) is a cross-sectional view of the elastic partition membrane taken along XIIb-XIIb line in FIG. 11 (a).

FIG. 13 (a) is a top plan view of a partition in the second embodiment, and FIG. 13 (b) is a cross-sectional view of the partition taken along XIIIb-XIIIb line in FIG. 13 (a).

FIG. 14 (a) and FIG. 14 (b) are graphical representations showing results of characteristics evaluation test.

FIG. 15 (a), FIG. 15 (b) and FIG. 15 (c) are a top plan view, a side elevation, and a bottom plan view, respectively, of an elastic partition membrane in a third embodiment.

FIG. 16 (a) is a cross-sectional view of the elastic partition membrane in the third embodiment taken along XVIa-XVIa line in FIG. 15 (a), and FIG. 16 (b) is a cross-sectional view of the elastic partition membrane taken along XVIb-XVIb line in FIG. 15 (a).

### DESCRIPTION OF REFERENCE CHARACTERS

100 hydraulic antivibration device
1 first attachment fitting
2 second attachment fitting
3 vibration-isolating base
8 liquid-filled chamber
9 diaphragm
11A first liquid chamber
11B second liquid chamber
12, 112 partition
15, 115, 215 elastic partition membrane
51, 151 displacement-regulating protrusion
251a, 251b displacement-regulating protrusion
52, 152, 252 auxiliary protrusion
16, 116 orifice member (sandwiching member)
18, 118 partition plate member (sandwiching member)
17, 19 displacement-regulating rib (radial rib)
117a, 119a displacement-regulating rib (annular rib)
117b, 119b displacement-regulating rib (linking rib)
54, 154a, 154b opening
56, 156a, 156b opening
25 orifice
O, P, Q axis center

### BEST MODE FOR CARRYING OUT THE INVENTION

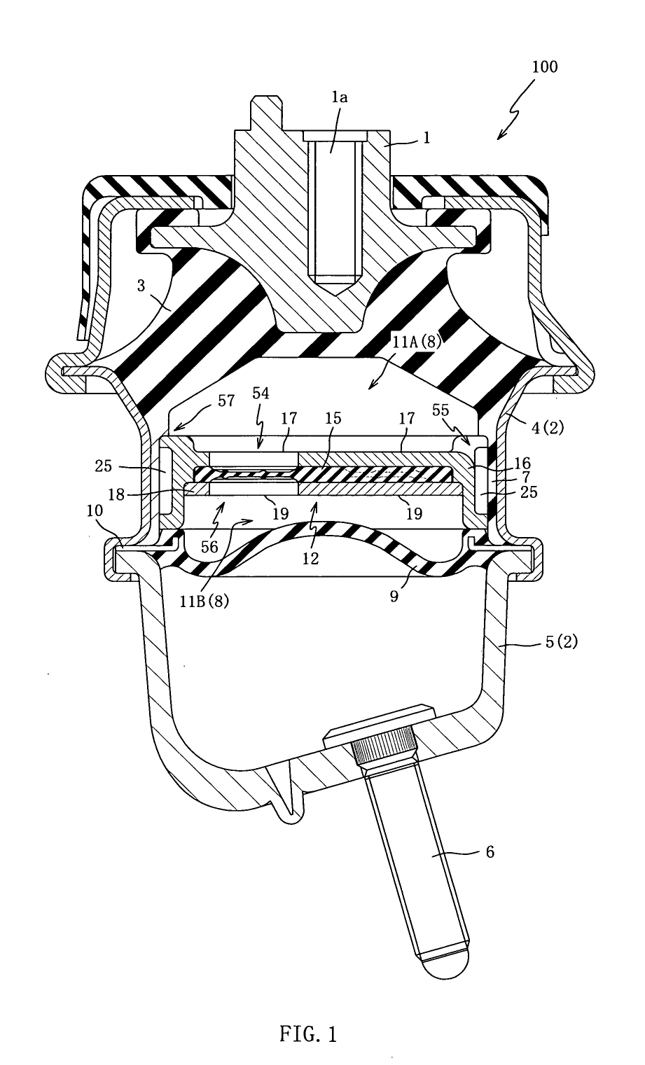

Preferred embodiments of the invention will be hereinafter described with reference to the accompanying drawings. FIG. 1 is a cross-sectional view of the hydraulic antivibration device 100 in the first embodiment.

This hydraulic antivibration device 100 is a vibration-controlling device for supporting and securing an engine of automobiles so as not to transmit vibrations of the engine to the vehicle body frame. As illustrated in FIG. 1, it comprises the first attachment fitting 1 to be attached to the engine side, the second attachment fitting 2 in a cylindrical shape to be attached to the body frame side beneath the engine, and the vibration-isolating base 3 composed of a rubber-like elastomer.

The first attachment fitting 1 is fabricated from a metal material such as aluminum in a generally columnar shape and bored, at its upper end face, with a female screw part 1a as shown in FIG. 1. At the outer periphery of the first attachment fitting 1, there is formed a generally flange-shaped projecting portion that is adapted to abut on a stabilizer fitting so as to perform a stopper action upon a large displacement.

The second attachment fitting 2 is made up of a cylindrical fitting 4 to which the vibration-isolating base 3 is vulcanization molded and a bottom fitting 5 attached to the underside of the cylindrical fitting 4. The cylindrical fitting 4 and the bottom fitting 5 are fabricated from an iron steel material, respectively, in a cylindrical shape having a splaying opening and in a cup shape having a slanting bottom. The bottom fitting 5 is provided at its bottom with a fitting bolt 6 in a projecting manner.

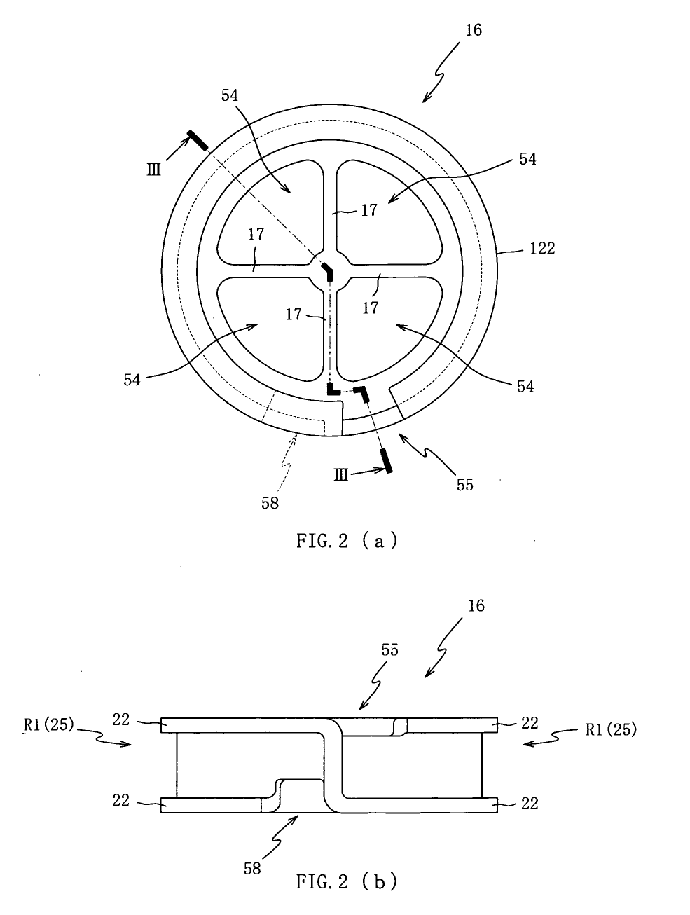

The vibration-isolating base 3 is fashioned in a conical frustum shape from a rubber-like elastomer and vulcanization bonded between the underside of the first attachment fitting 1 and the upper end opening of the cylindrical fitting 4. Further a rubber membrane 7 covering the inner peripheral face of the cylindrical fitting 4 joins at the underside of the vibration-isolating base 3, and an orifice-forming wall 22 (cf. FIG. 2) of the orifice member 16, which will be described below, closely fits with the rubber membrane 7 thus forming the orifice 25.

The diaphragm 9 is fashioned in a rubber membrane form having a partial sphere from a rubber-like elastomer, and fitted to the second attachment fitting 2 (between the cylindrical fitting 4 and the bottom fitting 5), as shown in FIG. 1. As a result, the liquid-filled chamber 8 is formed between the diaphragm 9 and the underside of the vibration-isolating base 3.

The liquid-filled chamber 8 is sealed with a non-freezing liquid (not shown) such as ethylene glycol. The liquid-filled chamber 8 is comparted by the partition 12, which will be described below, into two chambers of the first liquid chamber 11A and the second liquid chamber 11B.

The diaphragm 9 is, as shown in FIG. 1, fitted to the second attachment fitting 2 in a manner such that an attachment plate 10 in a donut form when viewed from the top plane is fixed between the cylindrical fitting 4 and the bottom fitting 5 by crimping. The partition 12 is infixed, with the outer periphery of the diaphragm and a step 57 of the vibration-isolating base 3 deformed under compression, to be pinched and held in the liquid-filled chamber 8 by reason of elastic recovery force of the diaphragm 9 (the outer periphery) and the vibration-isolating base 3 (the step 57).

The partition 12 is made up of the elastic partition membrane 15 fashioned in a disc-like form from a rubber membrane, the orifice member 16 accommodating the elastic partition membrane 15 on its inner peripheral face side and receiving the elastic partition membrane 15 with the displacement-regulating ribs 17, and the partition plate member 18 assuming a lattice disk form internally fitted from the opening beneath the orifice member 16 (the lower side in FIG. 1).

Between the outer peripheral face of the orifice member 16 and the inner peripheral face of the second attachment fitting 2, there is formed the orifice 25 as shown in FIG. 1. The orifice 25 is an orifice passage through which to put the first liquid chamber 11A and the second liquid chamber 11B into communication with each other and to fluidize the liquid between both liquid chambers 11A, 11B, and formed to extend about the axis center O of the orifice member 16 approximately one round.

The elastic partition membrane 15 is pinched and held at its full outer periphery between the orifice member 16 and the partition plate member 18 without clearance. Therefore the liquid within the liquid-filled chamber 8 by no means leaks through the openings 54, which will be described after, out of the first and the second liquid chambers 11A, 11B, but flows between the first and the second liquid chambers 11A, 11B only through the orifice 25.

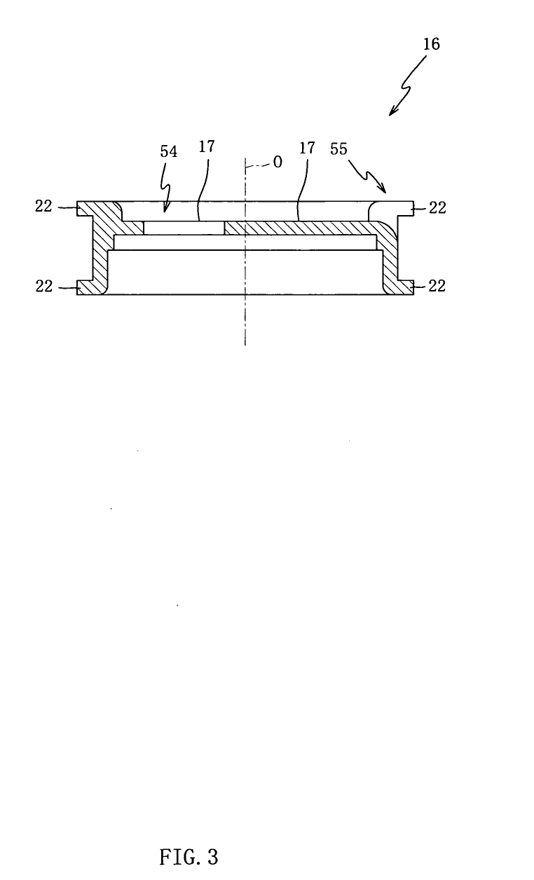

Now referring to FIGS. 2 and 3, the orifice member 16 constituting the partition 12 will be described. FIG. 2 (a) is a top plan view of the orifice member 16, and FIG. 2 (b) is a side elevational view of the orifice member 16. FIG. 3 is a cross-sectional view of the orifice member 16 taken along III-III line in FIG. 2 (a).

The orifice member 16 is fashioned, as shown in FIGS. 2 and 3, in a generally cylindrical shape having the axis center O from a metal material such as aluminum. At axially upper and lower ends of the orifice member 16, respective orifice-forming walls 22 in a generally flange shape are provided in a projecting manner, and between opposing faces of the orifice-forming walls 22 there is defined an orifice passage R1.

As described above, the respective orifice-forming walls 22 closely fit with the rubber membrane 7 covering the inner periphery of the cylindrical fitting 4, thereby forming the orifice 25 (cf. FIG. 1).

The upper and lower orifice-forming walls 22 are defined with cutouts 55, 58 respectively as shown in FIGS. 2 and 3. The one end of the orifice passage R1 communicates with the first liquid chamber 11A through the cutout 55 (cf. FIG. 1) whereas the other end of the orifice passage R1 communicates with the second liquid chamber 11B through the cutout 58.

In the inner periphery of the orifice member 16, as shown in FIGS. 2 and 3, there are pierced a plurality of openings (four in this embodiment) 54, alongside of peripheral margins of which a plurality of (four in this embodiment) displacement-regulating ribs 17 are provided.

The openings 54 are apertures provided as an escape for transmitting the hydraulic pressure fluctuation in the liquid-filled chamber 8 to the elastic partition membrane 15 and for avoiding the impingement on the elastic partition membrane 15 displaced by the hydraulic pressure fluctuation and pierced each in the form of a quartered circle.

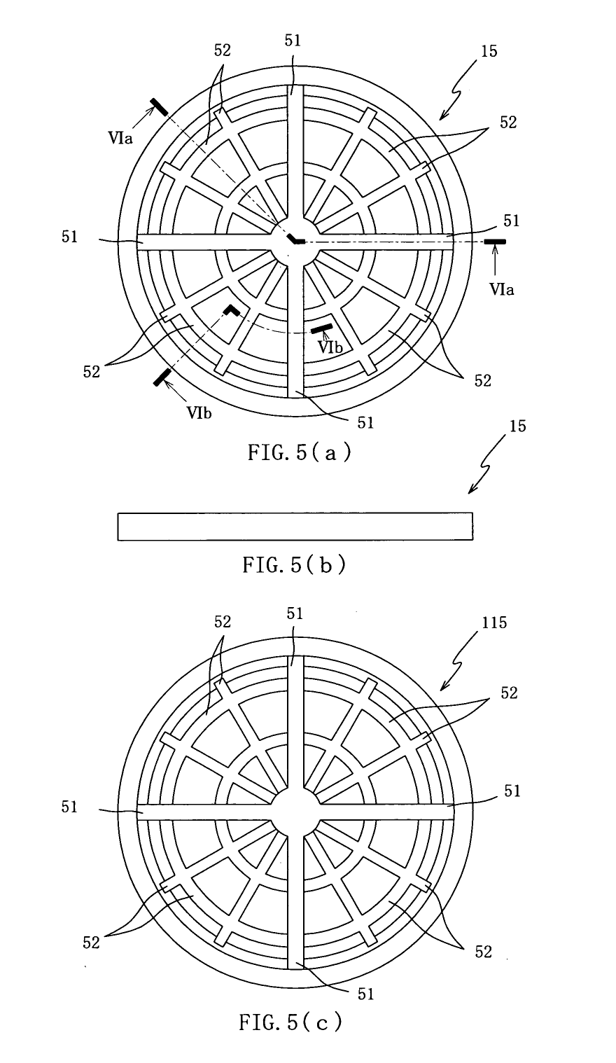

The displacement-regulating ribs 17 serve to abut on the displacement-regulating protrusions 51, which will be described below, of the elastic partition membrane 15 (cf. FIG. 5) thereby to restrain the elastic partition membrane 15, and are formed in a radial rectilinear fashion relative to the axis center O of the orifice member 16, as shown in FIG. 2.

The respective displacement-regulating ribs 17 are arranged equidistantly (90 degree intervals) in the circumferential direction, thus being disposed as a whole in a roughly crisscross fashion when viewed from the top plane, as illustrated in FIG. 2. The rib width and the rib thickness of the respective displacement-regulating ribs 17 are substantially the same.

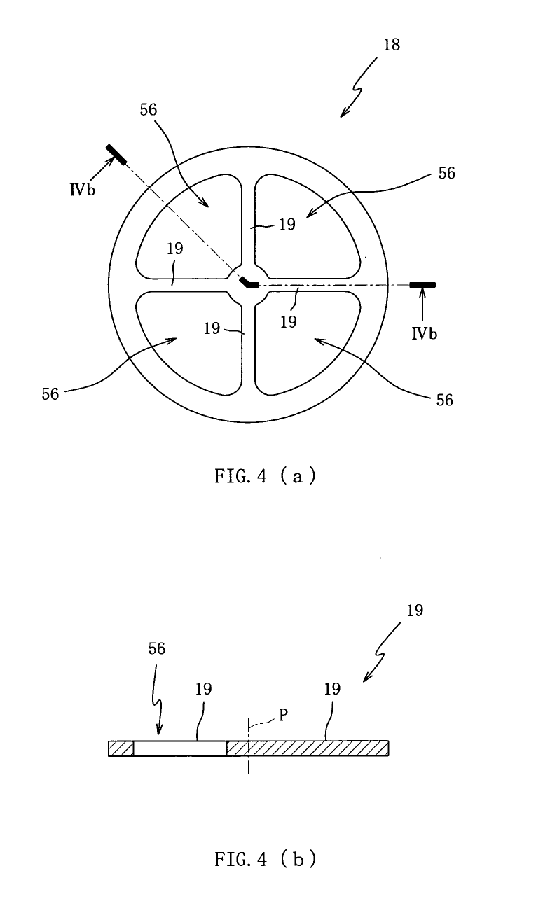

Referring to FIG. 4, the partition plate member 18 constituting the partition 12 will be described. FIG. 4 (a) is a top plan view of the partition plate member 18 and FIG. 4(b) is a cross-sectional view of the partition plate member 18 taken along IVb-IVb line in FIG. 4(a).

The partition plate member 18 along with the aforesaid orifice member 16 serves to pinch and hold the elastic partition membrane 15 for the purpose of regulating the displacement of the elastic partition membrane 15, and is formed in a disc shape having the axis center P.

On the inner periphery side of the partition plate member 18, as shown in FIG. 4, there are pierced a plurality of (four in this embodiment) openings 56, alongside of peripheral margins of which a plurality of (four in this embodiment) displacement-regulating ribs 19 are provided.

The openings 56 are apertures provided as an escape for transmitting the hydraulic pressure fluctuation of the liquid-filled chamber 8 to the elastic partition membrane 15 and for avoiding the impingement on the elastic partition membrane 15 displaced by the hydraulic pressure fluctuation, as is the case with the openings 54 (cf. FIG. 2).

The displacement-regulating ribs 19 are, similarly to the aforesaid displacement-regulating ribs 17 (cf. FIG. 2), to abut on the displacement-regulating protrusions 51 (cf. FIG. 5), which will be described below, of the elastic partition membrane 15, thus restraining the elastic partition membrane 15.

These openings 56 and the displacement-regulating ribs 19 are constructed in the same pattern (position, size, area, etc.) as that of the openings 54 and the displacement-regulating ribs 17 of the foregoing orifice member 16, and the description of them will be omitted, accordingly.

The partition plate member 18 is inserted from an opening of the orifice member 16 located at its lower part to be internally fitted in the inner periphery of the orifice member 16 (cf. FIG. 1). Here, the partition plate member 18 is, prior to the internal fitting, subjected to circumferential positioning so that the position of the displacement-regulating ribs 19 thereof may coincide with the position of the displacement-regulating ribs 17 of the orifice member 16. The positioning of the partition plate member 18 in the depth direction relative to the orifice member 16 is conducted by engaging the upper end of the partition plate member 18 with a step (cf. FIG. 3) formed on the inner periphery side of the orifice member 16.

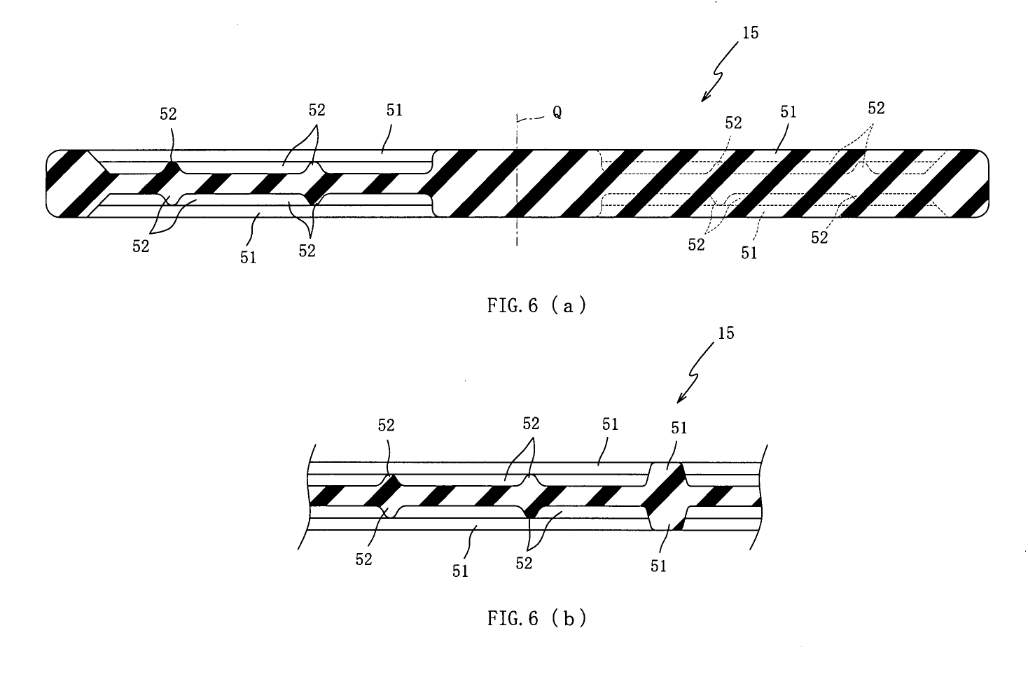

The elastic partition membrane 15 will be described with reference to FIGS. 5 and 6. FIGS. 5 (a), (b), (c) are respectively a top plan view, side elevational view, and a bottom plan view of the elastic partition membrane 15. FIG. 6 (a) is a cross-sectional view of the elastic partition membrane 15 taken along VIa-VIa line in FIG. 5 (a), and FIG. 6 (b) is a cross-sectional view of the elastic partition membrane 15 taken along VIb-VIb line in FIG. 5 (a).

The elastic partition membrane 15 is a rubber membrane configured in a generally disc shape from a rubber-like elastomer and housed within the partition 12, as described above and serves to mitigate the hydraulic pressure fluctuation between the first and the second liquid chambers 11A, 11B. At both the upside and the underside of the elastic partition membrane 15, the displacement-regulating protrusions 51 and the auxiliary protrusions 52 are provided respectively, as shown in FIGS. 5 and 6.

The displacement-regulating protrusions 51 are rib-like protrusions made to abut on the displacement-regulating ribs 17, 19 of the orifice member 16 and the partition plate member 18, respectively, and arranged in corresponding positions to the respective displacement-regulating ribs 17, 19. More specifically, the respective displacement-regulating ribs 51 in a plural number (four in this embodiment) are, as shown in FIG. 5, disposed in a radial rectilinear fashion relative to the axis center Q of the elastic partition membrane 15.

The respective displacement-regulating protrusions 51 are, as shown in FIG. 5, disposed substantially equidistantly (90 degree intervals) in the circumferential direction, thus being arranged as a whole in a crisscross form when viewed from the top plane, whereby the arrangement is made to correspond to the arrangements of the displacement-regulating ribs 17, 19.

The arrangement of the respective displacement-regulating protrusions 51 is symmetric on both upper and lower faces (upside and underside) of the elastic partition membrane 15, and the protrusion width and the protrusion height of the respective displacement-regulating protrusions 51 are also substantially the same, respectively.

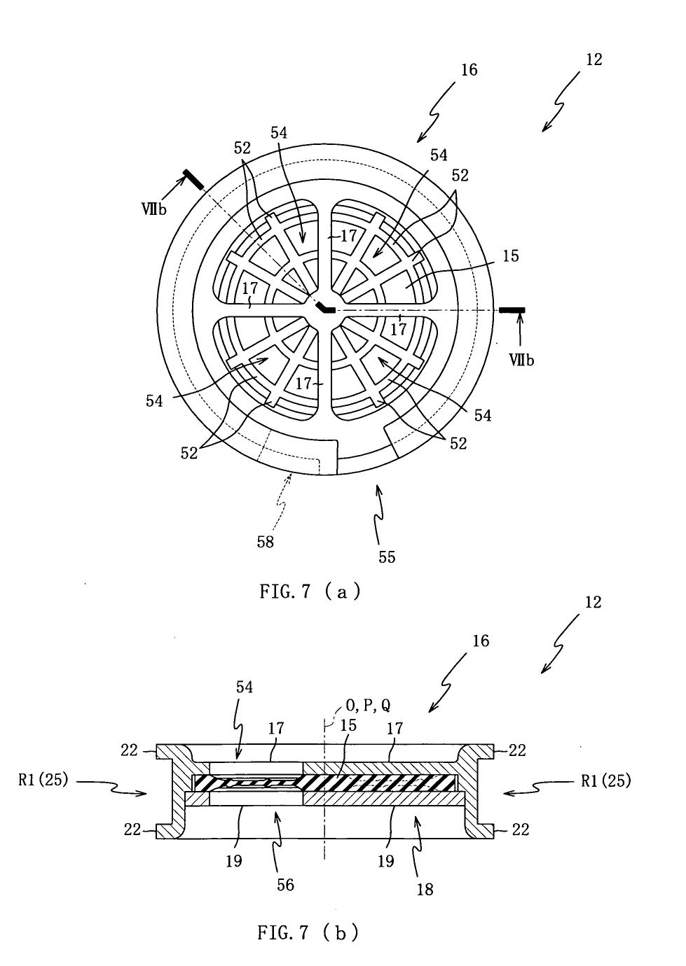

The protrusion height of the respective displacement-regulating protrusions 51 is, as shown in FIG. 6, made substantially the same as the height of the outer periphery of the elastic partition membrane 15. Thus in the assembled state of the partition 12 (cf. FIG. 7), the displacement-regulating protrusions 51 are put into abutment on the displacement-regulating ribs 17, 19, with tops thereof somewhat compressed.

Therefore, no clearance is produced between the displacement-regulating protrusions 51 and the displacement-regulating ribs 17, 19, so that even if the elastic partition membrane 15 is displaced, attended with inputting of a large amplitude, no impingement of the tops of the displacement-regulating protrusions 51 on the displacement-regulating ribs 17, 19 occurs. As a consequence, it is possible to avoid the generation of strange sounds ascribed to the impingement of the displacement-regulating protrusions 51 and the displacement-regulating ribs 17, 19 to the extent that it is possible to reduce further the generation of strange sounds.

The auxiliary protrusions 52 are rib-like protrusion for preventing the occurrence of failure of the elastic partition membrane 15 such as rupture of the membrane, and formed, as shown in FIGS. 5 and 6, in a combination of radial position moiety and annular position moiety relative to the axis center Q of the elastic partition membrane 15. The protrusion height and the protrusion width of the respective auxiliary protrusion 52 are substantially the same, respectively.

The auxiliary protrusions 52 are set to be narrower in protrusion width and lower in protrusion height than the displacement-regulating protrusions 51, and hence it is possible to suppress a rise in stiffness of the elastic partition membrane 15 as a whole, thereby maintaining a low dynamic spring characteristic upon inputting of small amplitude.

Now the assembled state of the partition 12 will be described with reference to FIG. 7. FIG. 7 (a) is a top plan view of the partition 12, and FIG. 7 (b) is a cross-sectional view of the partition 12 taken along VIIb-VIIb line in FIG. 7 (a).

In the assembled state of the partition 12, the position of the displacement-regulating ribs 17 of the orifice member 16 and the position of the displacement-regulating ribs 19 of the partition plate member 18, when viewed in the axial direction shown in FIG. 7 (a), coincide with each other in the circumferential direction, and the elastic partition membrane 15 is accommodated within the partition 11 so that the position of the displacement-regulating protrusions 51 thereof coincide with the positions of the displacement-regulating ribs 17, 19 in the circumferential direction, namely in the state that the tops of the displacement-regulating protrusions 51 abut on the displacement-regulating ribs 17, 19.

As a result, according to the hydraulic antivibration device 100 of this invention, upon inputting of a small amplitude, the elastic partition membrane 15 alleviates effectively the hydraulic pressure difference between the first and the second liquid chambers 11A, 11B, similarly to the conventional elastic membrane structure, whereby it is possible to reduce the dynamic spring value. On the other hand, upon inputting of a large amplitude, the displacement-regulating ribs 17, 19 can regulate the displacement of the elastic partition membrane 15 to elevate the stiffness of the elastic partition membrane 15 as a whole to the extent that it is possible to elevate the damping characteristic.

Again, upon inputting of a large amplitude, a non-displacement-regulating area (area not restrained by the displacement-regulating ribs 17, 19) of the elastic partition membrane 15 largely displaces. However, at the orifice member 16 and the partition plate member 18, the residual spaces other than the displacement-regulating ribs 17, 19 are formed as the openings 54, 56 as shown in FIG. 7, and hence, abutment of the non-displacement-regulating area of the elastic partition membrane 15 on the orifice member 16 or the partition plate member 18 can be avoided. As a result, it is possible to achieve a great reduction of strange sounds while meeting both of a low dynamic spring characteristic upon inputting of a low amplitude and a high damping characteristic upon inputting of a high amplitude.

Further according to the hydraulic antivibration device 100 of this invention, because the displacement-regulating protrusions 51 of the elastic partition membrane 15 are disposed in corresponding positions to the displacement-regulating ribs 17, 19, when the elastic partition membrane 15 displaces, attended with inputting of a large amplitude, the displacement-regulating protrusions 51, whose displacement is regulated by the displacement-regulating ribs 17, 19, are deflected in the compression direction, by which deflection amount it is possible to more elevate the stiffness of the elastic partition membrane 15 as a whole. As a consequence, it is possible to enhance more the damping characteristic upon inputting of a large amplitude.

Here, in order to obtain a low dynamic spring characteristic upon imputing of a small amplitude, it is required to make the hardness of the elastic partition membrane 15 low or to make the thickness of the membrane thin, but doing so renders the strain amount of the elastic partition membrane 15 large, so that its durability is reduced. According to the hydraulic antivibration device 100 of the invention, however, the restraint effect by the displacement-regulating ribs 17, 19 makes it possible to suppress the displacement amount (strain amount) of the elastic partition membrane 15 and consequently, it is possible to ensure a substantially equal low dynamic spring characteristic to that of the conventional elastic membrane structure and simultaneously to elevate the durability of the elastic partition membrane 15 itself.

The elastic partition membrane 15 in the first embodiment is provided with the displacement-regulating protrusions 51 in all positions corresponding to the respective displacement-regulating ribs 17, 19, as described above.

That is, eight displacement-regulating protrusions 51 in total (cf. FIG. 5) are provided on the upper and lower faces of the elastic partition membrane 15 in corresponding positions to eight displacement-regulating ribs 17, 19 in total at the upside and underside (cf. FIGS. 2 and 4). As a consequence, no clearance is produced between the displacement-regulating ribs 17, 19 and the elastic partition membrane 15, and hence it is possible to avoid the impingement of the elastic partition membrane 15 on the displacement-regulating ribs 1, 19 upon inputting of a large amplitude, to suppress sufficiently the generation of strange sounds.

However, the invention is not necessarily limited to this example, and it is naturally possible to make the number of the displacement-regulating protrusions 51 of the elastic partition membrane 15 less than the number of the displacement-regulating ribs 17, 19. In this embodiment, for example, the number of the displacement-regulating protrusions 51 of the elastic partition membrane 15 may be reduced to two per each face thereof (the upside and underside) (four in total).

More particularly, assuming that the respective displacement-regulating protrusions 51 are disposed in positions corresponding to the respective displacement-regulating ribs 17, 19, the number, n, of the displacement-regulating ribs 17, 19 is preferred to be two times or less the number, m, of the displacement-regulating protrusions 51 (n≦2m). Here, “n” and “m” stand for an integer, throughout the description given below.

In addition to this condition, it is more preferred to satisfy further condition that the number difference between the displacement-regulating ribs 17, 19 and the displacement-regulating protrusions 51 is 2 or less (n−m≦2). This is because thereby it is also possible to reduce sufficiently strange sounds while enhancing the stiffness of the displacement-regulating ribs 17, 19 as a whole to ensure the durability of them.

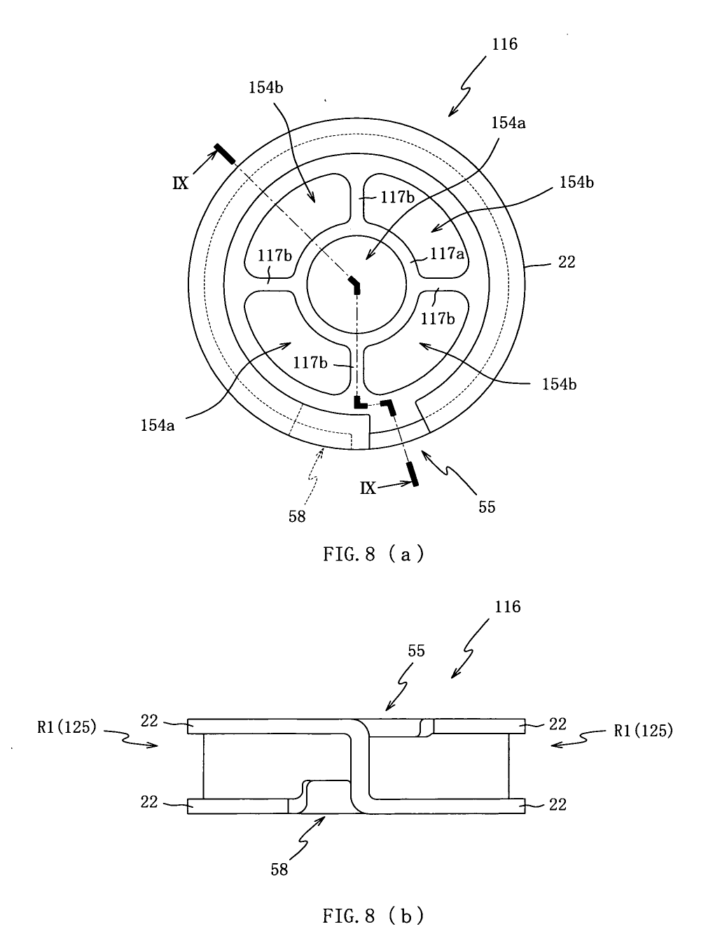

In the following, a second embodiment will be described with reference to FIGS. 8 through 13. In the first embodiment above, the displacement-regulating protrusions 51 of the elastic partition membrane 15 are disposed in a radial rectilinear fashion whereas in the second embodiment, the displacement-regulating protrusion 151 of the elastic partition membrane 115 is disposed in an annular fashion. Like parts to those in the first example described above are designated by like reference characters, and the description of them is omitted.

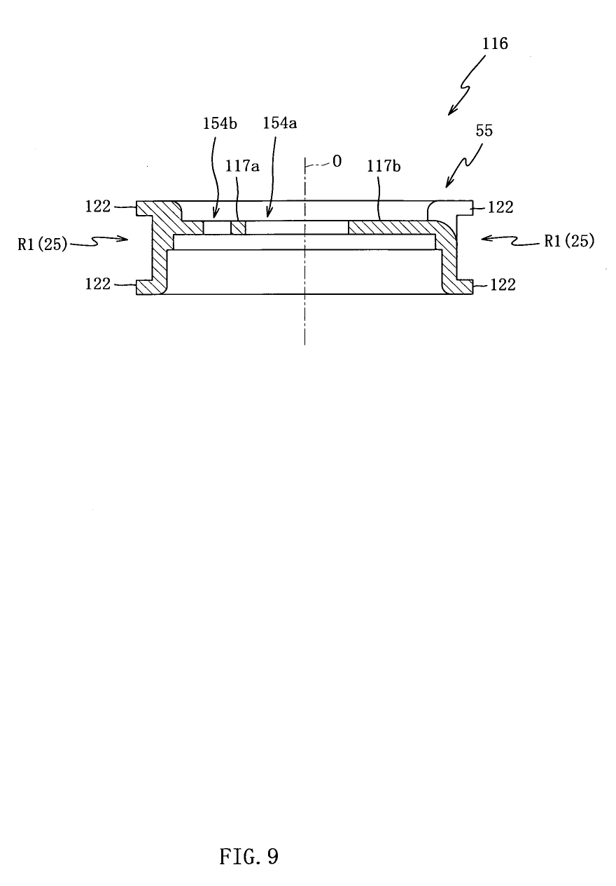

Firstly with reference to FIG. 8, the orifice member 116 will be described. FIG. 8 shows the orifice member 116 in the second embodiment of this invention, wherein (a) is a top plan view of the orifice member 116 and (b) is a side elevation of the orifice member 116. FIG. 9 is a cross-sectional view of the orifice member taken along IX-IX line in FIG. 8 (a).

As shown in FIGS. 8 and 9, the orifice member 116 is pierced, on its inner periphery side, with a plurality of (five in this embodiment) openings 154a, 154b, alongside of peripheral margins of which a plurality of displacement-regulating ribs 117a, 117b (one annular and four radial ones in this embodiment) are provided.

The openings 154a, 154b are provided as an escape for transmitting the hydraulic pressure fluctuation in the liquid-filled chamber 8 to the elastic partition membrane 115 and for avoiding the impingement on the elastic partition membrane 115 displaced by the hydraulic pressure fluctuation.

As shown in FIGS. 8 and 9, the shape of the opening 154a is a circle concentric with the axis center O of the orifice member 116 whereas the shape of the openings 154b is such a shape that a circumferentially extending annular hole is quartered in a radial fashion.

The displacement-regulating rib 117a is, likewise with the first embodiment, a rib for abutting on the displacement-regulating protrusion 151 of the elastic partition membrane 115 (cf. FIG. 11) to arrest the elastic partition membrane 115 whereas the displacement-regulating ribs 117b are ribs for holding the displacement-regulating rib 117a.

As shown in FIGS. 8 and 9, the displacement-regulating rib 117a is formed in an annular form concentric with the axis center O of the orifice member 116 and the displacement-regulating ribs 117b are formed in a radial rectilinear fashion relative to the axis center O of the orifice member 116.

The respective displacement-regulating ribs 117b are disposed substantially equidistantly (intervals of 90 degrees) in the circumferential direction. The rib width and the rib thickness of the respective displacement-regulating ribs 117a, 117b are substantially the same, respectively.

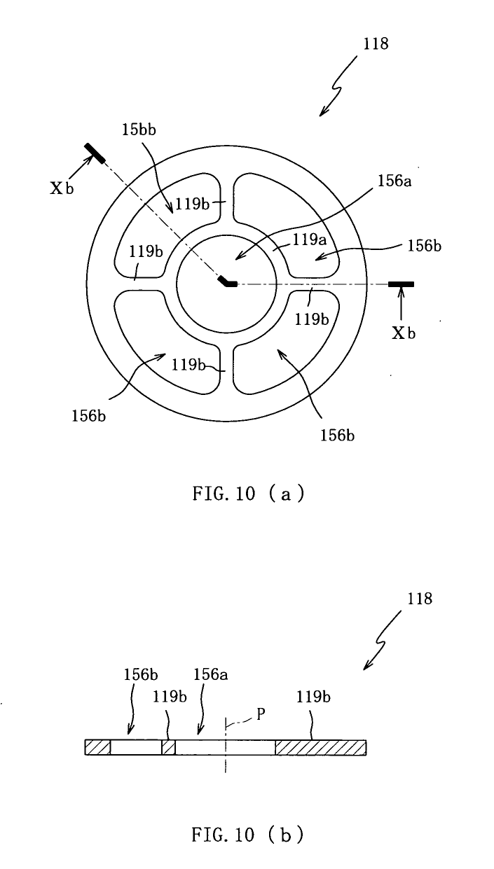

Now, description is made of the partition plate member 118 referring to FIG. 10. FIG. 10 (a) is a top plan view of the partition plate member 118 and FIG. 10 (b) is a cross-sectional view of the partition plate member 118 taken along Xb-Xb line in FIG. 10 (a).

The partition plate member 118 is, likewise in the first embodiment described above, a member for pinching and holding the elastic partition membrane 115 together with the orifice member 116 to regulate the displacement of the elastic partition membrane 115, and formed in a disc shape having the axis center P as shown in FIG. 10.

On the inner periphery side of the partition plate member 118, a plurality of (five in this embodiment) openings 156a, 156b are pierced, and alongside of peripheral margins of the openings 156a, 156b there are provided a plurality of displacement-regulating ribs 119a, 119b (one annular and four radial ones in this embodiment).

These openings 156a, 156b and displacement-regulating ribs 119a, 119b correspond to the openings 154a, 154b and the displacement-regulating ribs 117a, 117b of the orifice member 116 described above and are configured in the same pattern (position, size, area) as them, and hence, description of them is omitted.

The partition plate member 118 is infixed on the inner periphery of the orifice member 116 (cf. FIG. 13 (b)) and at that time, any circumferential positioning to the orifice member 116 is not needed unlike the case with the first embodiment described above. This is because whether or not the circumferential position of the displacement-regulating ribs 119b coincides with the position of the displacement-regulating ribs 117b does not affect the generation of strange sounds. Thereby it is possible to simplify the assembling of the partition 112 (infixing operation of the partition plate member 118 into the orifice member 116) to curtail the working cost.

At that time, because the orifice member 116 and the partition plate member 118 are formed integrally with the displacement-regulating ribs 117a, 117b, 119a, 119b of them, no complicated assembling work is required, unlike the case where these ribs 117a to 119b are formed in discrete bodies, to the extent that it is possible to reduce the assembling cost of the orifice member 116 and the partition plate member 118.

Further as compared with the case where these are formed separately, a distance between opposing faces of the elastic partition membrane 115 and the respective ribs 117a to 119b and a relative position of the respective ribs 117a to 119b to the elastic partition membrane 115 (the displacement-regulating protrusion 151) can be set accurately.

Referring to FIGS. 11 and 12, the elastic partition membrane 115 will be described. FIGS. 11 (a), (b), and (c) are a top plan view, a side elevation, and a bottom plan view, respectively, of the elastic partition membrane 115. FIG. 12 (a) is a cross-sectional view of the elastic partition membrane 115 taken along XIIa-XIIa line in FIG. 11(a) and FIG. 12 (b) is a sectional view of the elastic partition membrane 115 taken along XIIb-XIIb line in FIG. 11 (a).

The elastic partition membrane 115 is a rubber membrane configured in a generally disc form from a rubber-like elastomer, and serves to alleviate the hydraulic pressure difference between the first and second liquid chambers 11A, 11B.

On both faces, upside and underside, of the elastic partition membrane 115, there are each provided the displacement-regulating protrusion 151 and the auxiliary protrusions 152, as shown in FIGS. 11 and 12.

The displacement-regulating protrusions 151 are, as shown in FIG. 11, disposed in an annular fashion concentric with the axis center Q of the elastic partition membrane 115, and constructed in substantially the same diameter as the annular displacement-regulating ribs 117a, 119a of the orifice member 116 and the partition plate member 118 described above.

The arrangement of the displacement-regulating protrusions 151 is symmetric on both the upside and underside of the elastic partition membrane 115 and the protrusion width and the protrusion height of them are substantially the same, respectively.

Further, the protrusion height of the displacement-regulating protrusions 151 is, as shown in FIG. 12, made nearly the same as the outer periphery of the elastic partition membrane 115. Because of that, in the assembled state of the partition plate member 112 (cf. FIG. 13), the respective displacement-regulating protrusions 151 are made to abut on the displacement-regulating ribs 117a, 119a, with tops thereof somewhat compressed.

As a consequence, as is the case with the foregoing first embodiment, it is possible to avoid the generation of strange sounds attributed to impingement of the displacement-regulating protrusions 151 and the displacement-regulating ribs 117a, 119a, and to reduce more strange sounds by that amount.

The auxiliary protrusions 152 are ribs for preventing the occurrence of failure of the elastic partition membrane 115 such as rupture of the membrane, and disposed, as shown in FIGS. 11 and 12, in a radial rectilinear fashion relative to the axis center Q of the elastic partition membrane 115 in plural number (twelve in this embodiment). The protrusion height and the protrusion width of the auxiliary protrusions 152 are substantially the same respectively.

As shown in FIG. 12, because the auxiliary protrusions 152 are set to be lower in height than the displacement-regulating protrusions 151, it is possible to suppress a rise in stiffness of the elastic partition membrane 115 as a whole to maintain a low dynamic spring characteristic upon inputting of small amplitude.

Here, the elastic partition membrane 115 in the second embodiment is constructed so that the protrusion width of its displacement-regulating protrusions 151 is substantially the same as that of the auxiliary protrusions 152. That is, it is made narrower than the protrusion width of the displacement-regulating protrusions 151 in the aforesaid first embodiment. Thus where the displacement-regulating protrusions 151 are configured in an annular form, narrowing the protrusion width thereof in this manner enables it to maintain a low dynamic spring characteristic upon inputting of a small amplitude while obtaining a high damping characteristic upon inputting of a large amplitude.

Now the assembling state of the partition 112 will be described with reference to FIG. 13. FIG. 13 (a) is a top plan view of the partition 112 and FIG. 13 (b) is a sectional view of the partition 112 taken along XIIIb-XIIIb line in FIG. 13 (a).

The partition 112 is assembled so that the position of the displacement-regulating ribs 117b of the orifice member 115 coincides with the position of the displacement-regulating ribs 119b of the partition plate member 118 in the circumferential direction when viewed in the axial direction shown in FIG. 13 (a).

Here, the elastic partition membrane 115 is pinched and held, in a full circumference of its outer periphery, between the orifice member 116 and the partition plate member 118 without clearance, whereby leak of liquid between the first and the second liquid chambers 11A, 11B is prevented. Between the displacement-regulating ribs 117a and 119a, the protrusions 151 of the elastic partition membrane 115 are pinched and held in a somewhat compressed state.

In this second embodiment, the displacement-regulating protrusions 151 of the elastic partition membrane 115 are formed in a concentrically annular fashion. The concentrically annular displacement-regulating protrusions 151 are provided only in positions corresponding to the displacement-regulating ribs 117a, 119a of the orifice member 116 and the partition plate member 118 that are in a concentrically annular form.

Therefore in the assembling process of the partition 112, the working process steps can be simplified without the necessity of conducting the circumferential positioning of the elastic partition membrane 115 (the displacement-regulating protrusions 151) to the orifice member 116 (and the partition plate member 118) as is the case with the foregoing first embodiment, so that the working cost is curtailed and by that amount, it is possible to reduce the product cost of the overall hydraulic antivibration device.

According to the second embodiment as described above, it is possible to regulate effectively the displacement of the elastic partition membrane 115 by the displacement-regulating ribs 117a, 119a thus avoiding the impingement of the elastic partition membrane 115 and the orifice member 116 by the openings 154a, 154b to achieve a great reduction of strange sounds while achieving both a low dynamic spring characteristic upon inputting of low amplitude and a high damping characteristic upon inputting of high amplitude, as is the case with the first embodiment above.

Again as in the first embodiment, it is possible to elevate more the stiffness of the entirety of the elastic partition membrane 115 by deflecting the displacement-regulating protrusions 151 in the compression direction, attended with the displacement of the elastic partition membrane 115, so that it is possible to enhance more the damping characteristic upon inputting of large amplitude.

Further likewise as in the first embodiment, even though with a view to obtaining a low dynamic spring characteristic upon inputting of a small amplitude, the hardness of the elastic partition membrane 115 is made low or the thickness of the membrane is made thin, it is possible to suppress the displacement amount (strain amount) of the elastic partition membrane 115 owing to the effect of restraint by the displacement-regulating ribs 117a, 119a and by that amount, it is possible to enhance the durability of the elastic partition membrane 115 itself.

Referring to FIG. 14, results of characteristics evaluation test will be described.

Here, the hydraulic antivibration device 100 is required to achieve a low dynamic spring characteristic upon idling or upon inputting of small amplitude, e.g. booming noise range (generally, frequency: 20 Hz to 40 Hz, amplitude: ±0.05 mm to ±0.1 mm), a reduction of strange sounds upon inputting of a large amplitude, e.g. cranking vibration (generally, frequency: 10 Hz to 20 Hz, amplitude: ±1 mm to 2 mm) and a high damping characteristic upon inputting of an intermediate amplitude (shake range, etc.).

In this evaluation test of characteristics, measurement was made of the dynamic spring characteristic, strange sound characteristic, and damping characteristic using the hydraulic antivibration devices 100 in the first embodiment and the second embodiment (hereinafter referred to as “Example 1” and “Example 2”).

Example 1 and Example 2 are only different in construction of the partitions 12, 112 (cf. FIG. 7 and FIG. 13), but identical as to the shape and characteristics of other members.

For comparison purposes, hydraulic antivibration devices having respectively an elastic membrane structure and a mobile membrane structure (hereinafter referred to as “elastic membrane structure”, “mobile membrane structure”) were also measured of respective characteristics in the characteristics evaluation test.

Here, the elastic membrane structure is constructed so that the elastic partition membrane is disposed between the first and second liquid chambers so as to be able to absorb the hydraulic pressure fluctuation between both liquid chambers by the reciprocating deformation of the elastic partition membrane, wherein the elastic partition membrane is restrained only in its outer periphery. In contrast to the elastic membrane structure, the mobile membrane structure is constructed so that displacement-regulating members are provided on both sides of the elastic partition membrane so as to be able to regulate the displacement amount of the elastic partition membrane from both sides thereof by the displacement-regulating members.

FIG. 14 is a graphical representation showing results of characteristics evaluation test. In FIG. 14 (a), the ordinate indicates an acceleration value as an index of strange sounds output from the body frame side (the second attachment fitting 2 side) when a predetermined vibration (frequency: 15 Hz, amplitude: ±1 mm) is input from the engine side (the first attachment fitting 1 side), whereas the abscissa indicates a dynamic spring value upon idling (frequency: 30 Hz, amplitude: ±0.05 mm).

In FIG. 14 (b), the ordinate indicates a maximum (peak) value of damping characteristic obtained when the frequency is changed continuously while inputting an intermediate amplitude (±0.5 mm), and the abscissa indicates a dynamic spring value upon idling (frequency: 30 Hz, amplitude: ±0.05 mm).

When comparing the measurement results in FIG. 14 (a), it is shown in the mobile membrane structure that the strange sound characteristic and the dynamic spring characteristic are in a reciprocal relationship. That is, when the strange sound characteristic is designed to elevate, the dynamic spring characteristic upon idling (inputting of small amplitude) is aggravated (raised) and vice versa (when the dynamic spring characteristic is designed to be elevated, the strange sound characteristic is aggravated).

This is because with the mobile membrane structure, when the stiffness of the elastic partition membrane is raised, the abutment on the displacement-regulating members can be suppressed to reduce strange sounds, concomitantly with which the elastic partition membrane cannot mitigate sufficiently the hydraulic pressure difference between both liquid chambers, so that the dynamic spring value upon idling is raised.

In contradistinction, in Examples 1 and 2, the strange sound characteristic did not depend on the dynamic spring characteristic upon idling, as shown in FIG. 14 (a) and besides, extremely good results of strange sound characteristic equal to that of the elastic partition structure were obtained.

From these results, it was corroborated that by providing the orifice members 16, 116 with the openings 154, 154a, etc. to take advantage of them as an escape area for avoiding the impingement on the elastic partition membrane 15 displaced by the hydraulic pressure fluctuation as described above, it is possible to achieve a greater reduction of strange sounds upon inputting of a large amplitude than the mobile membrane structure while obtaining at least an equal low dynamic spring characteristic to that of the mobile membrane structure.

Then the measurement results in FIG. 14 (b) will be compared with the mobile membrane structure, because it is possible to regulate the displacement amount of the elastic partition membrane by the displacement-regulating members to elevate the stiffness of the elastic partition membrane, a high damping characteristic as shown in FIG. 14 (b) can be obtained. Nonetheless as described above, the strange sound characteristic ascribed to the abutment of the elastic partition membrane on the displacement-regulating members is extremely aggravated.

On the other hand, with the elastic partition membrane as shown in FIG. 14 (b), an extremely low damping characteristic was merely obtained. This is ascribed to the fact that because in the elastic membrane structure, the stiffness of the elastic partition membrane is not dependent on amplitude, but constant, when a low dynamic spring characteristic upon inputting of a small amplitude will be obtained, the hydraulic pressure difference between both liquid chambers is liable to be alleviated by the elastic partition membrane, so that the fluidization effect of fluid cannot be sufficiently exhibited.

In contrast, in Examples 1 and 2, where the dynamic spring characteristic upon idling is set to be equal to that of elastic membrane structure, a great enhancement of damping characteristic could be achieved, as shown in FIG. 14 (b).

From the results, it was corroborated that as described above, the displacement-regulating protrusions 51, 151 are arrested by the displacement-regulating ribs 17, 171a, etc. of the orifice members 16, 116 to regulate the displacement of the elastic partition membrane 15, 115, whereby it is possible to enhance greatly the damping characteristic while maintaining a low dynamic spring characteristic upon inputting of a small amplitude.

Thus far described above, according to the hydraulic antivibration device 100 of the invention, because the elastic partition membranes 15, 115 are arrested by the displacement-regulating ribs 17, 117a, etc. to regulate the displacement of them and the openings 54, 154a, etc. are pierced to provide the escapes for the elastic partition membranes 15, 115, it is possible to reduce greatly strange sounds upon inputting of a large amplitude while achieving both a low dynamic spring characteristic upon inputting of a low amplitude and a high damping characteristic upon a large amplitude (or intermediate amplitude).

The invention has been described so far on the basis of the first and the second embodiments, but it will be appreciated that this invention is not limited to them and various improvements and modifications are possible within the purview of the invention without departing from the purport and spirit thereof.

For example, in the first embodiment, the radial rectilinear arrangement of the displacement-regulating protrusions 51 and the displacement-regulating ribs 17, 19 relative to the axis centers O, P, Q has been described, but the rectilinear arrangement is not always necessary and it is naturally possible to arrange them in another geometry. For example, a whirling curve is exemplified.

On the other hand, in the second embodiment, description has been made of the case where the displacement-regulating protrusions 151 and the displacement-regulating ribs 117a, 119a are arranged in an annular form, but by the term “annular” is not meant necessarily a true circle only, and is meant to include also ellipsoidal and polygonal shapes.

Further the annular configurations in the displacement-regulating protrusions 151, etc. are not always necessary to be concentric with the axis centers O, P, Q of the orifice member 116, the partition plate member 118 and the elastic partition membrane 151, but respective centers of the respective annular configurations may be deviated from the axis centers O, P, Q.

Again in the second embodiment, the case where the elastic partition membrane 151 is provided with the annular displacement-regulating protrusions 151 only has been described, but this invention is not necessarily limited to this case, and the elastic partition membrane 151 may be also configured so that radial displacement-regulating protrusions in addition to the annular displacement-regulating protrusions 151 are provided.

Such configuration as this will be described as a third embodiment with reference to FIGS. 15 and 16. FIG. 15 show the elastic partition membrane 215 in the third embodiment, (a) to (c) being a top plan view, a side elevational view, and a bottom plan view, respectively, of the elastic partition membrane 215. FIGS. 16 (a) and (b) are cross-sectional views of the elastic partition membrane 215 taken along XVIa-XVIa line and XVIb-XVIb line, respectively, in FIG. 15 (a).

The elastic partition membrane 215 in the third embodiment is provided, as shown in FIGS. 15 and 16, with the displacement-regulating protrusions 251a disposed in an annular fashion concentric relative to an axis center T and a plurality of (four in this embodiment) displacement-regulating protrusions 251b disposed in a radial rectilinear fashion relative to the axis center T The elastic partition membrane 215 is also provided with the auxiliary protrusions 252.

The concentrically annular displacement-regulating protrusions 251a are configured in substantially the same diameter as the annular displacement-regulating ribs 117a, 119a of the orifice member 116 and the partition plate member 118. On the other hand, the respective radial rectilinear displacement-regulating protrusions 251b are disposed equidistantly in the circumferential direction (intervals of 90 degrees) as shown in FIG. 15 (a), which arrangement corresponds to the arrangements of the radial displacement-regulating ribs 117b, 119b of the orifice member 16 and the partition plate member 118.

The displacement-regulating protrusions 251a, 251b are configured in substantially the same protrusion width and the same protrusion height, respectively. The protrusion height of the displacement-regulating protrusions 251a, 251b are made substantially identical to the height of the outer periphery of the elastic partition membrane 215, as shown in FIG. 16 and the tops of them are set to be capable of abutment on the displacement-regulating ribs 117a, 117b, 119a, 119b.

When the elastic partition membrane 215 in this third embodiment is, in use, accommodated in the orifice member 116 and the partition plate member 118 in the second embodiment, because the displacement-regulating protrusions 251a, 251b are provided in all positions corresponding to the displacement-regulating ribs 117a, 117b, 119a, 119b with no clearance between the respective displacement-regulating ribs 117a to 119b and the elastic partition membrane 215, it is possible to avoid the impingement of the displacement-regulating ribs 117a to 119b on the elastic partition membrane 215 upon inputting of large amplitudes thereby to suppress sufficiently generation of strange sounds.

The aforesaid embodiment is illustrative only and should not be construed as limiting the invention to this embodiment. Of course it is possible to make the number of the displacement-regulating protrusions 251b of the elastic partition membrane 215 less than the number of the displacement-regulating ribs 117b, 119b. In the third embodiment, for example, the displacement-regulating protrusions 251b of the elastic partition membrane 215 may be decreased to one per one face (upside and underside) thereof (two in total).

However, where the number of the displacement-regulating protrusions 251b of the elastic partition membrane 215 is thus made less than the number of the displacement-regulating ribs 117b, 119b, it is preferred to provide at least one or more of the displacement-regulating protrusions 251b on at least either face, the upside or underside, of the elastic partition membrane 215. This is because the generation of strange sounds can be suppressed by that number of the displacement-regulating protrusions 251b.

More particularly, presupposing that the displacement-regulating protrusions 251b are disposed in corresponding positions to the displacement-regulating ribs 117b, 119b, the number, n, of the displacement-regulating ribs 117b, 119b in relation to the number, m, of the displacement-regulating protrusions 251b is more preferred to satisfy the condition of: n≦2 m+2.

In addition to this condition, more preferred is that a difference in number between the displacement-regulating ribs 117b, 119b and the displacement-regulating protrusions 251b is 2 or less (n−m≦2). This is because it is thereby possible to reduce sufficiently strange sounds while elevating the stiffness of the displacement-regulating ribs 117b, 119b as a whole to ensure the durability.

In the respective embodiments described above, the case where the displacement-regulating protrusions 51, 151, 251a, 251b are provided so as to project from the elastic partition membrane 15, 151, 251 has been described, but the invention is not intended to be limited to this, but such a configuration is also possible that these displacement-regulating protrusions 51, 151, 251a, 251b are provided to project from the displacement-regulating ribs 17, 19, 117a, 117b, 119a, 119b.

Again in the respective embodiments above, the case where the elastic partition membranes 15, 115, 215 are provided with the auxiliary protrusions 52, 152, 252 has been described, but the invention is not intended to be limited to this. It is naturally possible to omit the provision of these auxiliary protrusions 52, 152, 252.

Further in the respective embodiments above, in the assembled state of the partitions 12, 112, the protrusion height of the displacement-regulating protrusions 51, 151, 251a, 251b are set so that tops of them may abut on the displacement-regulating ribs 17, 19, 117a, 117b, 119a, 119b, but this is not limitative, and the protrusion height may be set so that there is formed a clearance between the tops and the displacement-regulating ribs 17, 19, 117a, 117b, 119a, 119b. Such clearance is preferably about 0.3 mm or less in the assembled state of the partitions 12, 112.

Further in the respective embodiments above, description has been made of the case that the elastic partition membranes 15, 115, 215 are vulcanization molded in a single body and pinched and held between the orifice members 16, 116 and the partition plate members 18, 118 to construct the partitions 12, 112, but the invention is not necessarily limited to this and it is naturally possible to construct so that the elastic partition membranes 15, 115, 215 are vulcanization bonded to one or both of the orifice members 16, 115 and the partition plate members 18, 118.

In the embodiments above, the description has been made of the case where the invention is applied to the so-called single orifice type of hydraulic antivibration device 100, wherein the first liquid chamber 11A and the second liquid chamber 11B are put in communication with each other through one orifice 125, but this invention is not necessarily limited to this and it is naturally possible to apply this invention to a so-called double orifice type of hydraulic antivibration device.

Here by the term “double orifice type hydraulic antivibration device” is meat the one that is comprised of a main liquid chamber, a first and a second subsidiary liquid chambers, and a first and a second orifices bringing the first subsidiary liquid chamber and the second subsidiary liquid chamber, respectively, and the main liquid chamber into communication with each other.

### INDUSTRIAL APPLICABILITY

According to the hydraulic antivibration device of the first invention, upon inputting of small amplitude, it is possible to mollify effectively the hydraulic pressure difference between the first and second liquid chambers by the elastic partition membrane similarly to the conventional elastic membrane structure thereby to reduce the dynamic spring value. On the other hand, upon inputting of a large amplitude, because the displacement of the elastic partition membrane is regulated by the displacement-regulating ribs of the sandwiching members, the stiffness of the elastic partition membrane as a whole is elevated by the influence of restraint by the displacement-regulating ribs, and the damping characteristic can be enhanced by that amount.

And when this large amplitude is input, non-displacement-regulating part (part not arrested by the displacement-regulating ribs) of the elastic partition membrane is to be displaced greatly. However because the residual area other than the displacement-regulating ribs of the sandwiching members is pierced by the openings, it is possible to avoid the abutment of the elastic partition membrane on the sandwiching members. As a result, the effect accrues that it is possible to satisfy both a low dynamic spring characteristic upon inputting of a small amplitude and a high damping characteristic upon inputting of a large amplitude, and simultaneously to reduce greatly strange sounds.

Further, at least on one face side of the elastic partition membrane there are provided displacement-regulating protrusions in positions corresponding to the displacement-regulating ribs of the sandwiching members. Because of that, when the elastic partition membrane is displaced, attended with inputting of a large amplitude, the displacement is regulated by the displacement-regulating ribs and the displacement-regulating protrusions deflect in the compression direction. By the amount contributed by the displacement-regulating protrusions, the stiffness of the elastic partition membrane as a whole can be elevated more, as a result of which the effect accrues that the damping characteristic upon inputting of large amplitude can be enhanced.

In order to obtain a low dynamic spring characteristic upon inputting of a small amplitude, it is necessary to make the hardness of the elastic partition membrane low or the thickness of the membrane thin, which leads to a large strain amount of the elastic partition membrane and consequently, causes a reduction in durability thereof. However, according to the invention, it is possible to suppress the displacement amount of the elastic partition membrane by reason of restraint by the displacement-regulating ribs and hence, the effect accrues that it is possible to enhance the durability of the elastic partition membrane itself while ensuring a low dynamic spring characteristic substantially equal to that of the conventional elastic membrane structure.

According to the hydraulic antivibration device of the second invention, the additional effect to the effects achieved by the hydraulic antivibration device of the first invention accrues: because the displacement-regulating protrusions are provided on both face sides of the elastic partition membrane, whether the elastic partition membrane is displaced toward either the first liquid chamber or the second liquid chamber, attended with inputting of a large amplitude, it is possible to deflect the displacement-regulating protrusions in the compression direction between the displacement-regulating ribs and the displacement-regulating protrusions to contribute to a rise in stiffness of the entirety of the elastic partition membrane and accordingly, to enhance more the damping characteristic upon inputting of large amplitude by that amount.

According to the hydraulic antivibration device of the third invention, in addition to the effects achieved by the hydraulic antivibration device of the first or the second invention, an effect is achieved in that because the displacement-regulating protrusions are configured so that the tops thereof may abut on the displacement-regulating ribs, namely no clearance is provided between the displacement-regulating protrusions and the displacement-regulating ribs, even though the elastic partition membrane is displaced with inputting of a large amplitude, it is possible to avoid the generation of strange sounds ascribed to the impingement of the tops of displacement-regulating protrusions on the displacement-regulating ribs, thus achieving a further reduction of strange sounds by that amount.

According to the hydraulic antivibration device of the fourth invention, in addition to the effects achieved by any one of the hydraulic antivibration devices of the first to the third inventions, the effect accrues that generation of strange sounds can be suppressed. That is, if the displacement-regulating protrusions are not provided in corresponding positions to the displacement-regulating ribs, there is produced a clearance between the displacement-regulating ribs and the elastic partition membrane, so that the elastic partition membrane impinges upon inputting of a large amplitude, which is responsible for generation of strange sounds. However the number of the displacement-regulating ribs contributing to such generation of strange sounds is reduced to less than a half its total number, and hence, it is possible to suppress sufficiently the generation of strange sounds.

On the other hand, for the displacement-regulating ribs is required an intensity in stiffness for regulating the displacement of the elastic partition membrane upon inputting of a large amplitude. However, when the displacement-regulating ribs not provided with the displacement-regulating protrusions in corresponding positions are disposed, it is possible to elevate the stiffness of the sandwiching members (displacement-regulating ribs) as a whole by that disposed amount to reduce a load acting on the respective displacement-regulating ribs, and consequently, it is possible to enhance also the durability of the sandwiching members (displacement-regulating ribs).

According to the hydraulic antivibration device of the fifth invention, in addition to the effects achieved by any one of the hydraulic antivibration devices of the first to the third inventions, the effect accrues that the generation of strange sounds can be suppressed. That is, because the displacement-regulating protrusions are not provided in corresponding positions to the linking ribs and a clearance is produced between the elastic partition membrane and the linking ribs, the elastic partition membrane impinges on the linking ribs upon inputting of a large amplitude, which is responsible for the generation of strange sounds. Here, however, the number of the linking ribs is made four or less, and consequently, it is possible to suppress sufficiently the generation of strange sounds.

The annular ribs are preferred to be disposed in a concentrically annular fashion relative to the axis center of the sandwiching members. That is, when the displacement-regulating protrusions are provided only in positions corresponding to the annular ribs as in this invention, in the assembling process steps of the partition, it is possible to simplify the working steps without the necessity of conducting circumferential positioning of the elastic partition membrane (displacement-regulating protrusions) relative to the sandwiching members (annular ribs). Therefore the effect accrues that it is possible to reduce the working cost to the extent that the cost as a product of the overall hydraulic antivibration device can be reduced.

According to the hydraulic antivibration device of the sixth invention, in addition to the effects achieved by any one of the hydraulic antivibration devices of the first to the third inventions, the effect accrues that it is possible to suppress the generation of strange sounds. More specifically, if the displacement-regulating protrusions are not provided in positions corresponding to the linking ribs, a clearance is produced between the displacement-regulating ribs and the elastic partition membrane, so that upon inputting of a large amplitude, the impingement of the elastic partition membrane occurs, which is responsible for generation of strange sounds. However, here, in positions corresponding to at least one linking ribs, of a plurality of the linking ribs, the displacement-regulating protrusions of the elastic partition membrane are provided and hence, it is possible to suppress the generation of strange sounds by that amount.

On the other hand, for the linking ribs is required an intensity in stiffness for regulating the displacement of the elastic partition membrane upon inputting of a large amplitude and supporting the annular ribs. When the linking ribs not provided with the displacement-regulating protrusions are disposed in corresponding positions, it is possible to enhance the stiffness of the sandwiching members (the annular ribs and the linking ribs) as a whole by that disposed amount thereby to reduce the load acting on the respective linking ribs, and to the extent it is also possible to enhance the durability of the sandwiching members (displacement-regulating ribs).

According to the hydraulic antivibration device of the seventh invention, in addition to the effects achieved by the hydraulic antivibration device of the sixth invention, the effect accrues that it is possible to suppress sufficiently the generation of strange sound. That is, as described above, if the displacement-regulating protrusions are not provided in corresponding positions to the linking ribs, the elastic partition membrane impinges upon inputting of a large amplitude, which is responsible for generation of strange sounds. However, the displacement-regulating protrusions of the elastic partition membrane are provided in positions corresponding to the linking ribs of [n/2−1 (n: even number), or (n+1)/2−1 (n: odd number)] or upwards, among the linking ribs of n, and hence, it is possible to suppress sufficiently the generation of strange sounds.

According to the hydraulic antivibration device of the eighth invention, in addition to the effects achieved by the one of the sixth invention or the seventh invention, the effect accrues that it is possible to suppress further more the generation of strange sounds. That is, as described above, if the displacement-regulating protrusions are not provided in corresponding positions to the linking ribs, the elastic partition membrane impinges on the linking ribs, which is responsible for the generation of strange sounds. However, the displacement-regulating protrusions of the elastic partition membrane are provided in positions corresponding to the linking ribs of (n−2) or upwards, wherein 2 is deducted from the total number, n, of the linking ribs, namely so that the number of the linking ribs contributing to generation of strange sounds may be 2 or less, and consequently, it is possible to suppress further more generation of strange sounds.

According to the hydraulic antivibration device of the ninth invention, in addition to the effects achieved by any one of the hydraulic antivibration devices of the fourth to the eighth inventions, the effect accrues that because the displacement-regulating ribs or the annular ribs and the linking ribs are formed integrally with the sandwiching members, it is possible to reduce the working cost without the necessity of conducting a complex assembling work as is the case where these are formed in discrete bodies. Moreover as compared with the case where discrete bodies are formed, it is possible to set a distance between opposing faces of the elastic partition membrane and the respective ribs and a relative position of the ribs to the elastic partition membrane (displacement-regulating protrusions) precisely, so that it is possible to achieve the effect that further reduction of strange sounds can be attained.

According to the elastic partition membrane of the tenth invention, it is possible to achieve similar effects to the elastic partition membrane used for any one of the hydraulic antivibration devices of the first to the ninth invention.

According to a pair of the sandwiching members of the eleventh invention, it is possible to achieve similar effects to the sandwiching members used for any one of the hydraulic antivibration devices of the first to the ninth invention.

1. A hydraulic antivibration device comprising a first attachment fitting, a cylindrical second attachment fitting, a vibration-isolating base connecting the second attachment fitting and the first attachment fitting together and composed of a rubber-like elastomer, a diaphragm attached to the second attachment fitting and forming a liquid-filled chamber between the diaphragm and the vibration-isolating base, a partition comparting the liquid-filled chamber into a first liquid chamber on the vibration-isolating base side and a second liquid chamber on the diaphragm side, and an orifice bringing the first liquid chamber and the second liquid chamber into communication with each other, the partition including an elastic partition membrane and a pair of sandwiching members pinching and holding a peripherally marginal portion of the elastic partition membrane from both faces thereof,
which device is characterized in that the sandwiching members include a plurality of openings pierced on the first liquid chamber side and on the second liquid chamber side and displacement-regulating ribs regulating the displacement of the elastic partition membrane formed alongside of peripheral margins of the respective openings;
the elastic partition membrane includes displacement-regulating protrusions that are provided at least on one face side thereof so as to protrude from there and disposed in positions corresponding to at least a part of the displacement-regulating ribs of the sandwiching members.

2. The hydraulic antivibration device as set forth in claim 1, characterized in that the displacement-regulating protrusions of the elastic partition membrane are provided on both faces thereof and are disposed in positions corresponding to at least a part of the displacement-regulating ribs of the respective sandwiching members.

3. The hydraulic antivibration device as set forth in claim 1 or 2, characterized in that the displacement-regulating protrusions of the elastic partition membrane are configured so that tops thereof may abut on the displacement-regulating ribs of the sandwiching members.

4. The hydraulic antivibration device as set forth in claims 1 or 2, characterized in that the displacement-regulating ribs of the sandwiching members are of a plurality of radial ribs arranged in a radial fashion relative to an axis center of the sandwiching members; and
the displacement-regulating protrusions of the elastic partition membrane are provided in positions corresponding to at least a half or more of a plurality of the radial ribs.

5. The hydraulic antivibration device as set forth in claims 1 or 2, characterized in that the displacement-regulating ribs of the sandwiching members include annular ribs disposed in an annular fashion relative to an axis center of the sandwiching members and a plurality of linking ribs joining the annular ribs to outer peripheries of the sandwiching members and disposed in a radial fashion relative to the axis center of the sandwiching members; and
the displacement-regulating protrusions of the elastic partition membrane are disposed only in positions corresponding to the annular ribs and the number of the linking ribs is four or less.

6. The hydraulic antivibration device as set forth in claims 1 or 2, characterized in that the displacement-regulating ribs include annular ribs disposed in an annular fashion relative to the axis center of the sandwiching members and a plurality of linking ribs joining the annular ribs to outer peripheries of the sandwiching members and disposed in a radial fashion relative to the axis center of the sandwiching members; and
the displacement-regulating protrusions of the elastic partition membrane are provided in positions corresponding to the annular ribs and in positions corresponding to at least one linking rib or more, of a plurality of the linking ribs.

7. The hydraulic antivibration device as set forth in claim 6, characterized in that assuming the number of said linking ribs to be n, the displacement-regulating protrusions of the elastic partition membrane are provided in positions corresponding to the annular ribs and in positions corresponding to the linking ribs of [n/2−1 (n: even number) or (n+1)/2−1 (n: odd number)] or upwards, among the linking ribs of n pieces.

8. The hydraulic antivibration device as set forth in claim 6, characterized in that assuming the number of said linking ribs to be n, the displacement-regulating protrusions of the elastic partition membrane are provided in positions corresponding to the annular ribs, and in positions corresponding to the linking ribs of (n−2) or upwards, wherein 2 is deducted from the total number, n, of the linking ribs.

9. The hydraulic antivibration device as set forth in claim 4, characterized in that the displacement-regulating ribs or the annular ribs and the linking ribs are formed integrally with the sandwiching members.

10. An elastic partition membrane characterized in that it is employed for the hydraulic antivibration device as set forth in claims 1 or 2.

11. A pair of sandwiching members characterized in that they are employed for the hydraulic antivibration device as set forth in claims 1 or 2.
